(19) United States
(12) Patent Application Publication
(10) Pub. No.: US 2008/0243589 A1
(43) Pub. Date: Oct. 2, 2008

(54) Questionnaire-driven system configuration

(76) Inventors: Beng-Giap Lim, Mountain View, CA (US); Wei-Chung Chen, Mountain View, CA (US); Erin K. Horbach, Mountain View, CA (US); Cathrin A. Barsch, Los Gatos, CA (US)

Correspondence Address: SAP AG c/o BUCKLEY, MASCHOFF & TALWALKAR LLC, 50 LOCUST AVENUE, NEW CANAAN, CT, 06840, US

(21) Appl. No.: 11/728,789

(22) Filed: Mar. 27, 2007

(51) Int. Cl. G06F 17/30

(52) U.S. Cl. 705/10

(57) ABSTRACT

A system may determine a plurality of questions, each of the plurality of questions associated with one or more answer fields, associate each of a plurality of system configuration tasks with one or more of the one or more answer fields, and generate an executable questionnaire including the plurality of questions and indicating the plurality of system configuration tasks and the one or more of the one or more answer fields associated with each of the plurality of system configuration tasks. A system may also include receive an executable questionnaire comprising questions associated with answer fields, and indicating system configuration tasks associated with one or more of the answer fields, receive answers associated with the answer fields, and automatically generate a configuration project based on the received answers and on the system configuration tasks associated with one or more of the answer fields.

### FIELD

Some embodiments relate to enterprise management systems. In particular, some embodiments concern the configuration of business logic within an enterprise management system.

### BACKGROUND

An enterprise management system typically provides functions for managing, monitoring and executing many aspects of a large business. Such functions may include, for example, supply-chain management, customer relationship management, enterprise resource planning, and product lifecycle management. An enterprise management system may be designed for deployment within any type of business or may be specialized with respect to a particular type of business.

Regardless of the degree of specialization offered by a given conventional enterprise management system, a system must typically be tailored to some degree to meet the needs of the business within which it will be deployed. An enterprise management system may therefore provide a flexible architecture to facilitate such tailoring. For example, an enterprise management system may include business logic comprising many thousands of software modules to perform various functions. The business logic operates based on the code of the software modules and on settings information associated with the modules. The settings information may describe, among other things, how the modules are to operate, how the modules interact with one another, and how the modules interact with business data.

Tailoring an enterprise management system to a particular business therefore requires the creation of settings information that causes the software modules (i.e., the business logic) to operate as required by the particular business. According to one option, a business will purchase an enterprise management system and convey functional requirements of the business to an installer. The installer then creates settings information which will enable the business logic to operate according to the requirements. This option often entails prohibitive costs.

U.S. Patent Application Publication No. US 2006/0101374 describes a system to generate settings information using a semi-automated installation tool. Generally, an object manager creates a library of enterprise management system objects. These objects include settings information for causing business logic to operate in accordance with an associated business process. Next, an installation project manager assembles a group of the objects into a project and automatically installs the settings into the business logic. Such a system may reduce the costs associated with system installation, but still requires a significant degree of expertise.

Systems are therefore desired to facilitate the configuration of enterprise software such as an enterprise management system.

### BRIEF DESCRIPTION OF THE DRAWINGS

FIG. 1 is a block diagram of a system according to some embodiments.

FIG. 2 is a diagram illustrating nodes of a questionnaire according to some embodiments.

FIG. 3 is a flow diagram of a process to generate an executable questionnaire according to some embodiments.

FIG. 4 is a detailed block diagram of a system according to some embodiments.

FIG. 5 is an outward view of a questionnaire designer user interface window to define a question node according to some embodiments.

FIG. 6 is an outward view of a questionnaire designer user interface window to define a question node according to some embodiments.

FIG. 7 is an outward view of a user interface window to select system configuration tasks according to some embodiments.

FIG. 8 is an outward view of a user interface window to associate a system configuration task with one or more answer fields of one or more questions according to some embodiments.

FIG. 9 is an outward view of a graphical designer user interface window to define a question node according to some embodiments.

FIG. 10 is an outward view of a user interface window to define an action node according to some embodiments.

FIG. 11 is an outward view of a user interface window to define an action node according to some embodiments.

FIG. 12 is an outward view of a user interface window to define a decision node according to some embodiments.

FIG. 13 is an outward view of a user interface window to define a decision node according to some embodiments.

FIG. 14 is an outward view of a user interface window to submit answers associated with answer fields of a question according to some embodiments.

FIG. 15 is a flow diagram of a process to generate a configuration project according to some embodiments.

FIG. 16 is an outward view of a user interface window to administer received answers according to some embodiments.

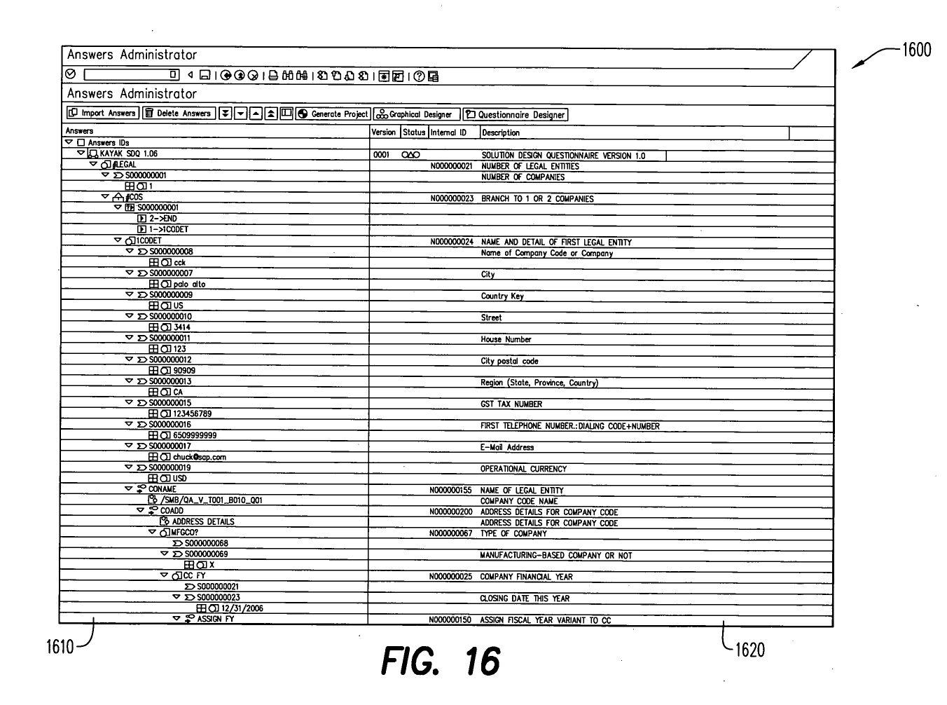

FIG. 17 is an outward view of a user interface window to generate a configuration project according to some embodiments.

FIG. 18 is an outward view of a user interface window to view system configuration tasks of a generated project according to some embodiments.

FIG. 19 is a block diagram of a hardware system according to some embodiments.

### DETAILED DESCRIPTION

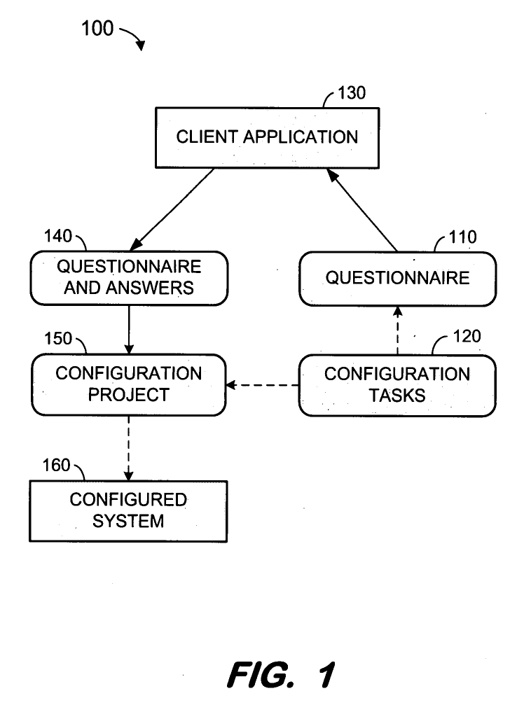

FIG. 1 is a block diagram of system 100 according to some embodiments. The elements of system 100 may be located remote from one another and may communicate with one another via a network and/or a dedicated connection. Moreover, each displayed element of system 100 may comprise any number of hardware and/or software elements suitable to provide the functions described herein, some of which are located remote from each other. Topologies other than that shown in FIG. 1 may be used in conjunction with some embodiments.

According to some embodiments, questionnaire 110 includes a plurality of questions. Each of the plurality of questions, in turn, is associated with one or more answer fields. Each question may be associated with a respective question node, and the question nodes may be ordered according to a desired questioning sequence. For purposes of the general example of FIG. 1, questionnaire 110 may comprise any arrangement of data represented in electronic form.

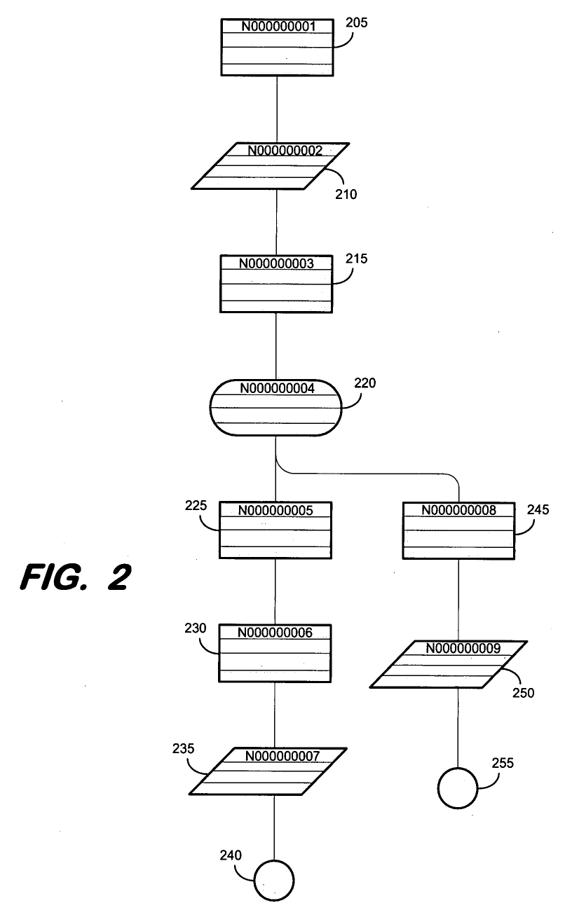

FIG. 2 shows graphical representation 200 of questionnaire 110 according to some embodiments. Representation 200 includes question nodes 205, 215, 225, 230, and 245, each of which is associated with a question. Each question of each question node is associated with one or more answer fields. The question nodes of representation 200 are ordered according to a desired questioning sequence. For example, the question of node 205 is to be presented before the question of node 215.

Upon reaching decision node 220, the questioning sequence proceeds to the question node (i.e., node 225 or node 245) indicated by decision node 220. The indication is based on an answer field associated with a question node preceding decision 220. In particular, the questioning sequence proceeds to node 225 of node 245 depending upon a received answer associated with an answer field of question node 205 or question node 215.

Returning to FIG. 1, configuration tasks 120 comprise one or more automated and/or manual tasks for configuring a software system. A configuration task 120 may be associated with one or more of the answer fields of questionnaire 110. According to some embodiments, the one or more answer fields represent answers which serve as inputs to the associated configuration task 120. Each of configuration tasks 120 may comprise one or more configuration objects. Examples of configuration tasks 120 and configuration objects will be provided below.

Action nodes 210, 235 and 250 of representation 200 may provide the foregoing association between a configuration task and one or more answer fields. Action node 210, for example, may specify one of configuration tasks 120 and one or more answer fields of question node 205 which may be used as inputs to the one configuration task 120.

Client application 130 may execute questionnaire 110 using any suitable technique, some of which will be described in detail below. According to a general example, client application 130 renders questionnaire 110 into a series of questions presented to a client according to representation 200. Client application 130 may, in some embodiments, comprise a Web browser executing a script for rendering the particular electronic format in which questionnaire 110 resides.

Client application 130 may receive answers from the client during execution of questionnaire 110. The answers may be associated with the answer fields of questionnaire 110. Questionnaire and answers 140 are output by client application 140 as shown in FIG. 1.

Configuration project 150 is generated based on questionnaire and answers 140. In this regard, questionnaire and answers 140 specify one or more configuration tasks 120, each of which is associated with one or more of the answer fields of questionnaire 110, as well as received answers that correspond to one or more of the answer fields. Accordingly, configuration project 150 may be generated by determining the specified configuration tasks, determining one or more of the specified configuration tasks for which all associated answer fields correspond to a received answer, and generating configuration project 150 to include the one or more of the specified configuration tasks.

Configuration project 150 may be executed to generate configured system 160. Configured system 160 may comprise an enterprise software system.

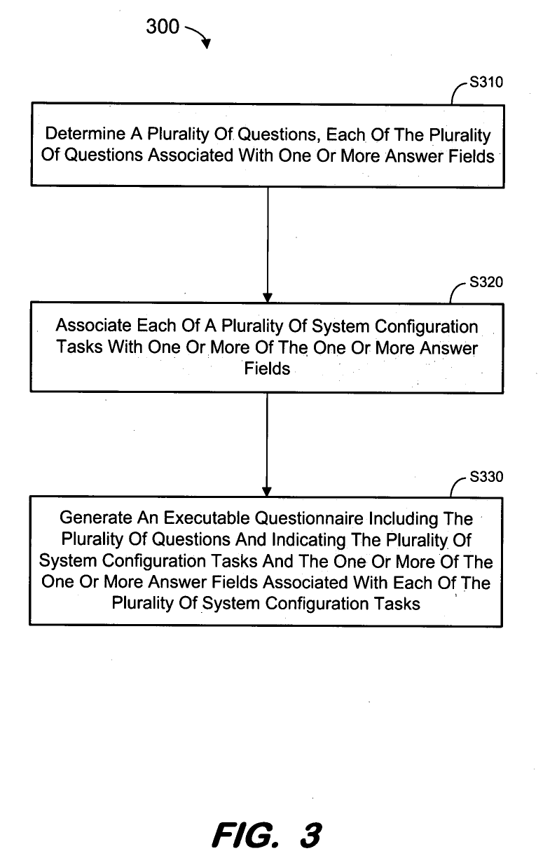

FIG. 3 is a flow diagram of process 300 according to some embodiments. Some embodiments of process 300 may provide an executable questionnaire such as, but not limited to, questionnaire 110 of FIG. 1.

Process 300 and all other processes mentioned herein may be embodied in processor-executable program code read from one or more of a computer-readable medium, such as a floppy disk, a CD-ROM, a DVD-ROM, a Zip™ disk, a magnetic tape, and a signal encoding the process, and then stored in a compressed, uncompiled and/or encrypted format. In some embodiments, hard-wired circuitry may be used in place of, or in combination with, program code for implementation of processes according to some embodiments. Embodiments are therefore not limited to any specific combination of hardware and software.

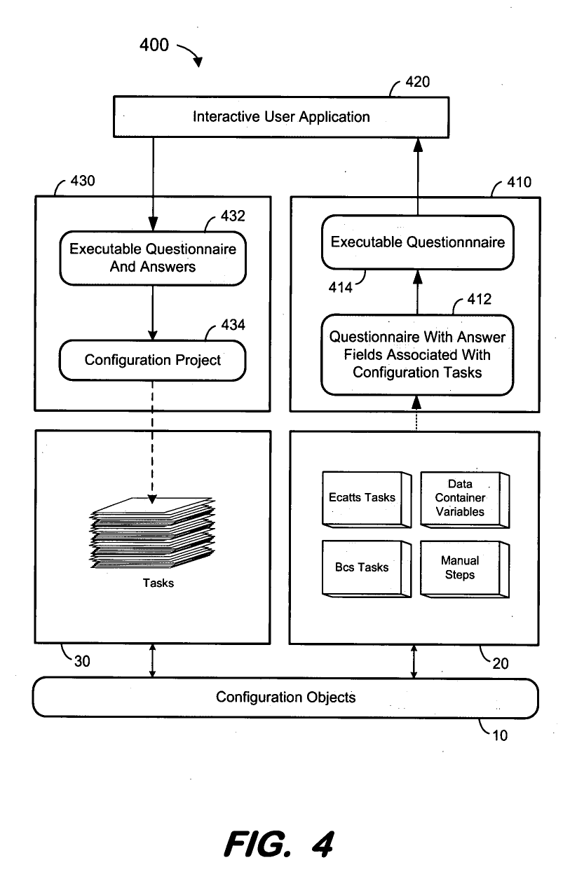

Initially, at S310, a plurality of questions is determined. Each of the plurality of questions is associated with one or more answer fields. Examples of S310 and the other elements of process 300 will be described as if executed by system 400 of FIG. 4. System 400 may comprise an implementation of system 100 of FIG. 1.

System 400 includes questionnaire designer 410 embodying process 300 according to some embodiments. As mentioned above, questionnaire designer 410 may comprise any suitable combination of hardware, program code, and other software. Questionnaire designer 410 may operate to generate questionnaire 412 having answer fields associated with configuration tasks and to generate executable questionnaire 414 from questionnaire 412. In some embodiments, questionnaire designer 410 comprises an Advanced Business Application Programming (ABAP®) application executing on an ABAP platform.

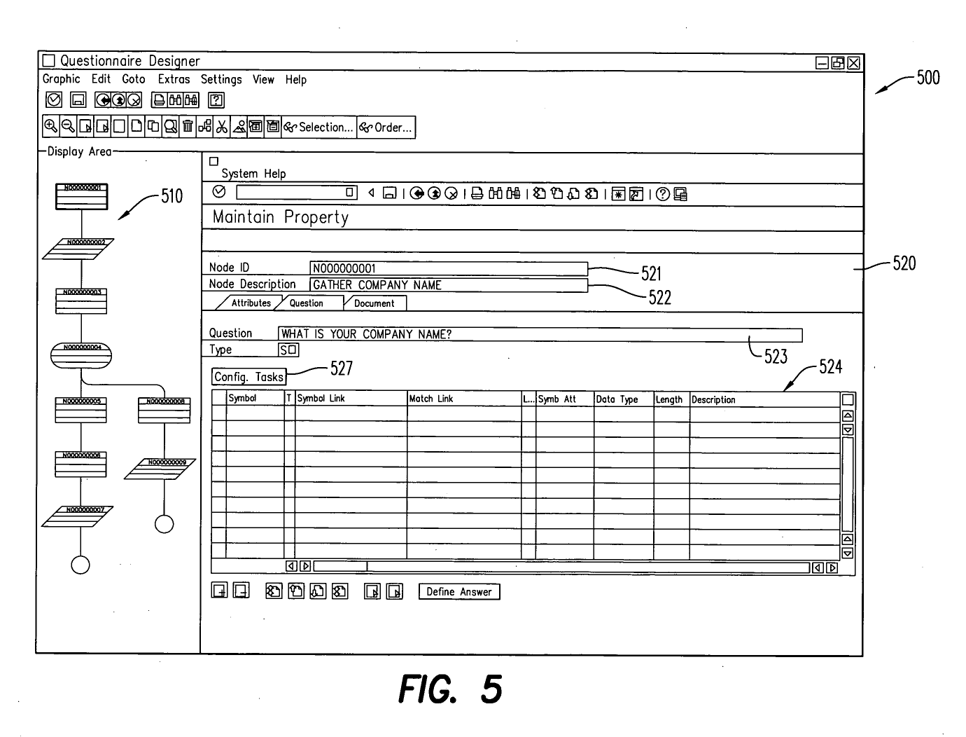

FIG. 5 is a view of user interface 500 of questionnaire designer 410 according to some embodiments. User interface 500 may be presented to a designer upon execution of questionnaire designer 410. With respect to S310, user interface 500 may be used to determine a plurality of questions and to associate each of the questions with one or more answer fields according to some embodiments.

User interface 500 presents representation 510 of questionnaire 412 according to some embodiments. The nodes of questionnaire 412 have already been defined prior to S310 for purposes of the illustrated example, but embodiments are not limited thereto.

User interface 500 includes node definition area 520. Area 520 may be used to define characteristics of a selected node of representation 520. Area 520 includes Node ID field 521 and Node Description field 522. Fields 521 and 522 may be completed with information for uniquely identifying the selected node with respect to other nodes of questionnaire 412.

Node definition area 520 includes Question field 523 because the selected node of representation 512 is a question node. The designer may input a question into Question field 523 to be associated with the selected question node. Answer field table 524 may then be used to associate the question with one or more answer fields.

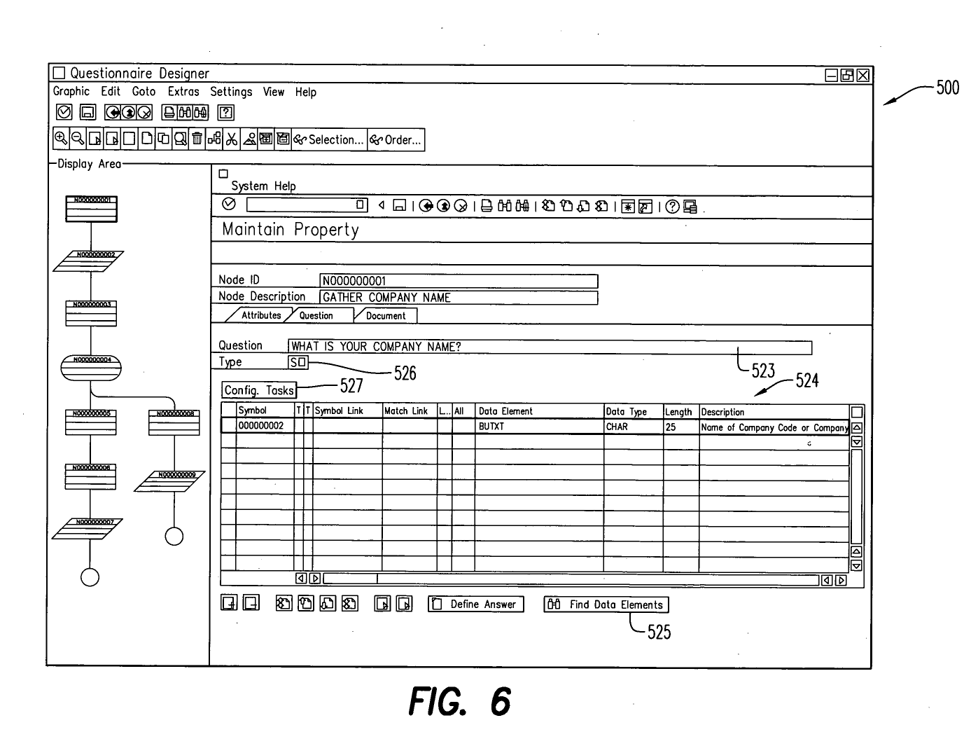

FIG. 6 illustrates association of a question with an answer field according to some embodiments. As shown in answer field table 524 of FIG. 6, one answer field is associated with the question set forth in Question field 523. The answer field may be associated with a Symbol, a Data type, a Length and a Description. In some embodiments, a designer may input a name of a system Data Element into a row of answer field table 524 and select button 525 to populate the aforementioned fields of the row.

The designer may manipulate Type pulldown menu 526 in order to associate more than one answer field with the defined question. For example, in a case that Question field 523 indicates. “What is the Company address?”, a designer may wish to define distinct answer fields for a Street Address, a City, a State, and a Zip Code.

Returning to FIG. 5, the one or more associated answer fields may also be defined using Configuration Tasks button 527. Configuration Tasks button 527 may provide access to data relating to enterprise management system objects as described in the Background. These enterprise management system objects include settings information for causing business logic to operate in accordance with an associated business process.

FIG. 4 shows configuration objects 10 which may be accessed through Configuration Tasks button 527. Configuration objects 10 may comprise any objects for performing configuration tasks provided by any one or more vendors. Configuration objects 10 may comprise business configuration sets (BC sets), programs, extended computer-aided test tools (eCATTS), and/or manual steps with instructions according to some embodiments. As shown in FIG. 4, objects 10 may be collected into configuration tasks 20 comprising two or more objects 10. A configuration task 20 may include two or more objects 10 which together may perform one logical configuration task.

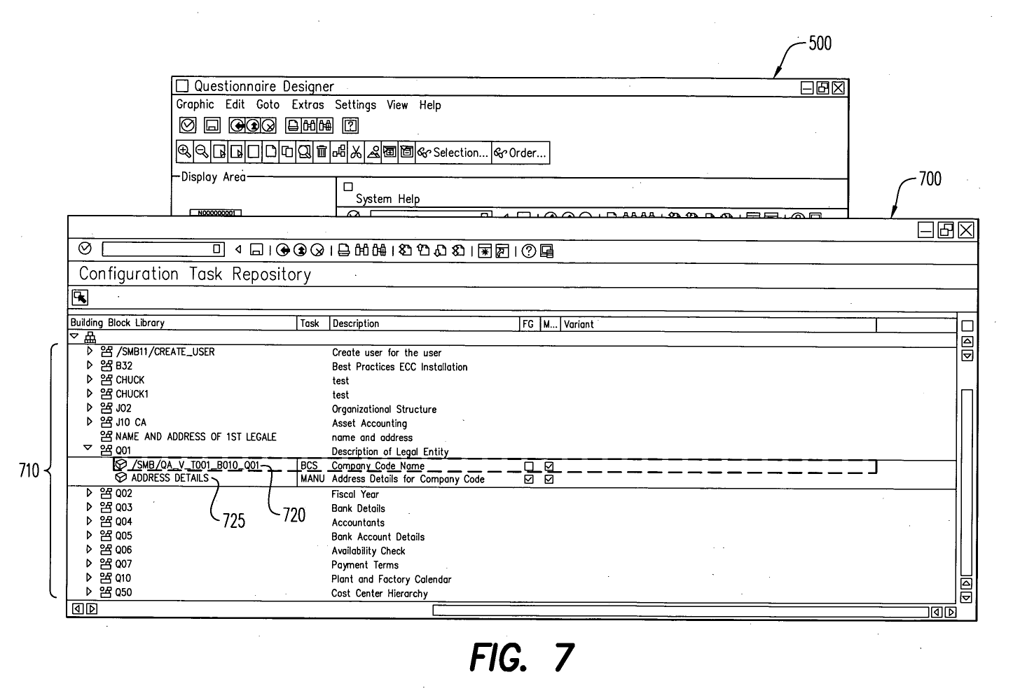

User interface 700 of FIG. 7 may be presented in response to selection of Configuration Objects button 527. User interface 700 shows configuration task libraries 710, one of which is expanded to show its constituent configuration tasks 720 and 725. For the present example, it will be assumed that the designer selects configuration task 720.

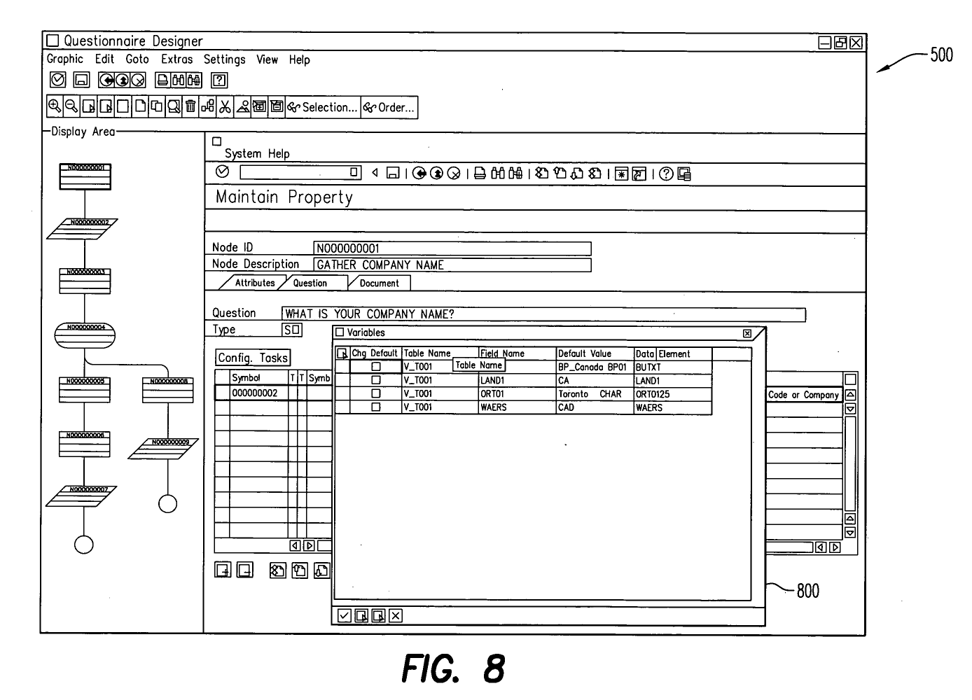

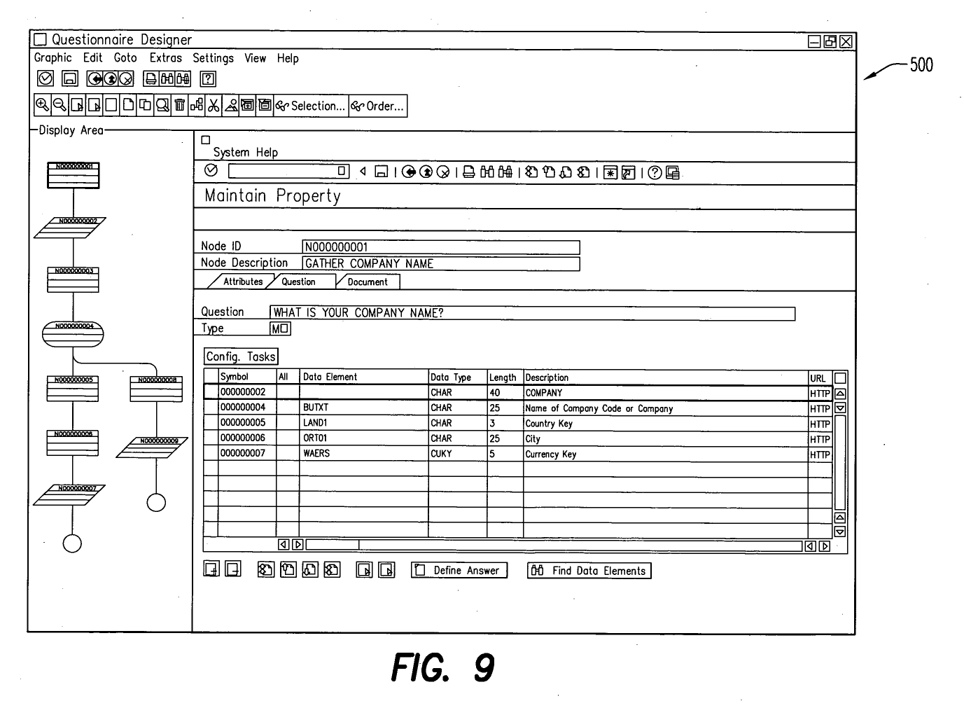

Window 800 of FIG. 8 presents input fields of the selected configuration task. Window 800 also includes default values for the input fields according to some embodiments. As shown in FIG. 9, a designer may select the input fields of window 800 in order to generate answer fields corresponding thereto. As a result, Configuration Tasks button 527 may allow a designer to define answer fields of a determined question that correspond to input fields of one or more configuration tasks.

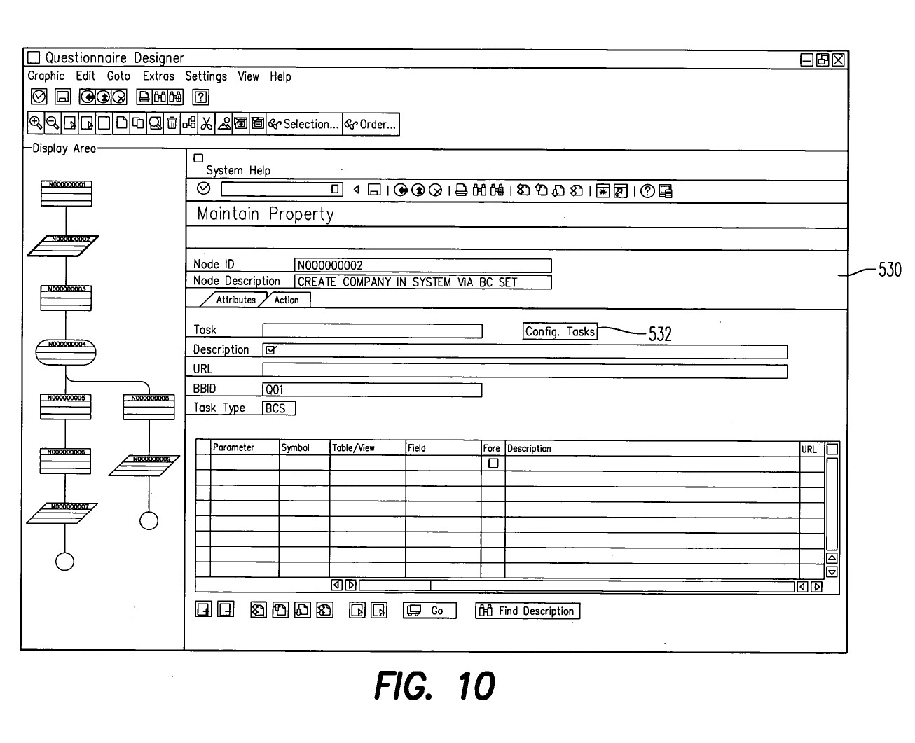

Returning to process 300, each of a plurality of system configuration tasks is associated with one or more of the answer fields at S320. The one or more answer fields, in turn, are associated with a previously-defined question. FIG. 10 shows Action Node definition area 530 for performing S320 according to some embodiments.

The fields of Action Node definition area 530 may be completed manually or with assistance from Configuration Tasks button 532. As an example of the latter scenario, selection of button 532 may result in display of window 700 of configuration task libraries as described above. In the present example, it will be assumed that the designer again selects task 720 and each of the input fields presented in window 800.

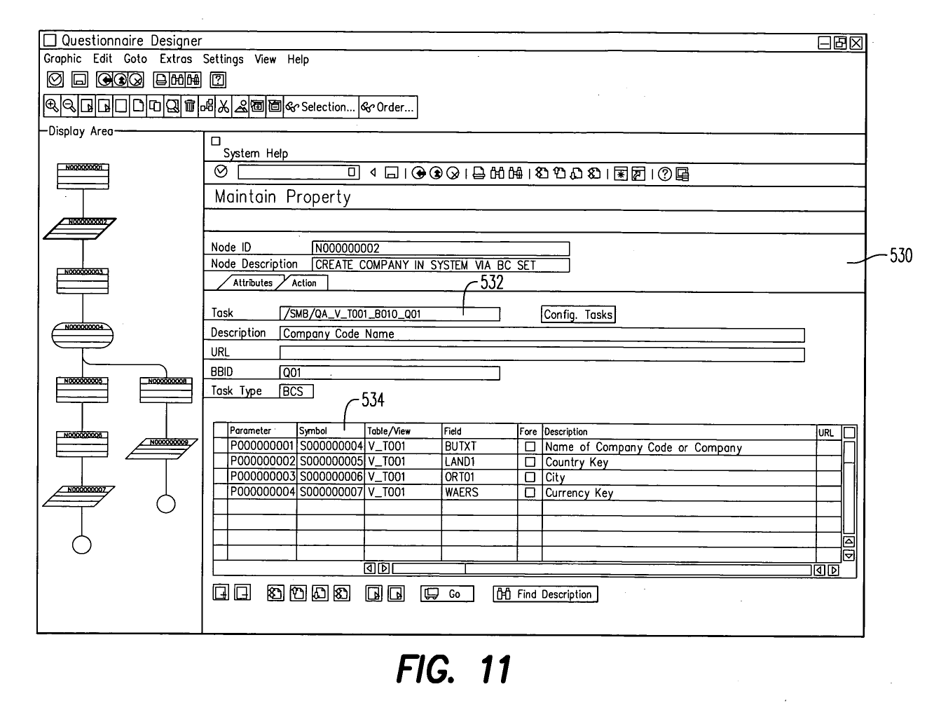

FIG. 11 shows Action Node definition area 530 after the above-described selection of the input fields. Task field 534 specifies a configuration task, and Symbol column 536 indicates answer fields of a question, each of which corresponds to input fields of the configuration task.

An executable questionnaire is then generated at S330. The executable questionnaire includes the plurality of determined questions, the plurality of system configuration tasks, and the one or more answer fields associated with each of the plurality of system configuration tasks.

Executable questionnaire 414 is generated in some embodiments of S330. Executable questionnaire 414 may comprise any format that may be executed by interactive user application 420. According to some embodiments, executable questionnaire 414 comprises an extended Markup Language (XML) document and application 420 comprises a Web browser executing a script (e.g., Java, Flash) capable of interpreting questionnaire 414 and rendering a page based thereon. Application 420 may also or alternatively comprise an ABAP application.

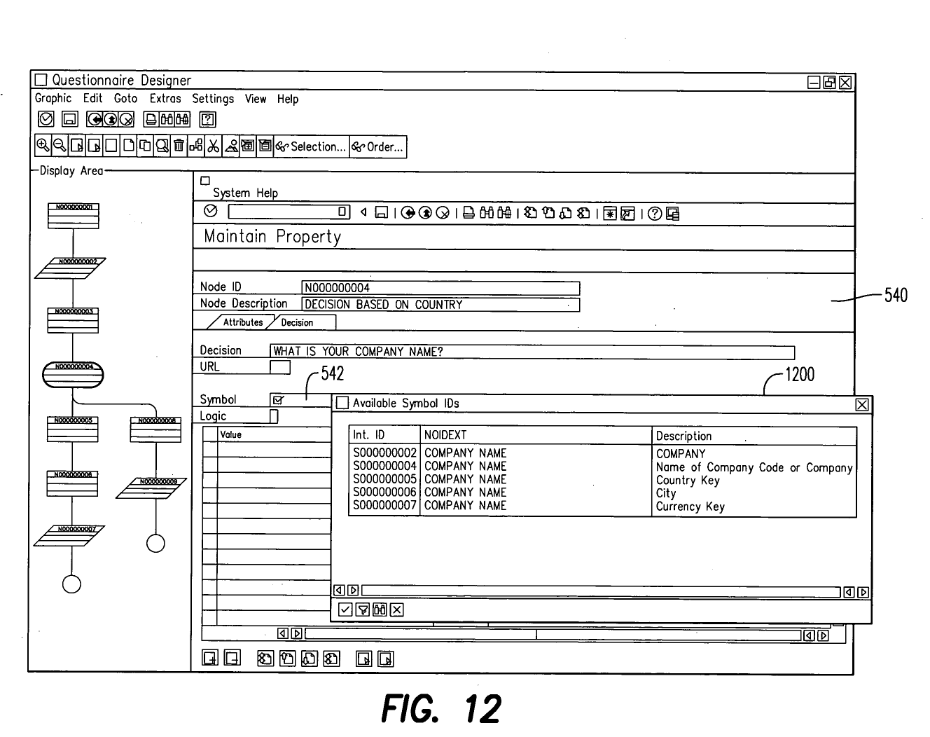

Some embodiments of 300 also comprise determining one or more decision node of the questionnaire prior to generating the executable questionnaire. Decision node definition area 540 of FIG. 12, for example, includes Symbol field 542 for specifying a previously-defined answer field. The selected decision node indicates to which question node (e.g., question node N00000005 or N000000008) a questioning sequence will proceed based on the specified answer field.

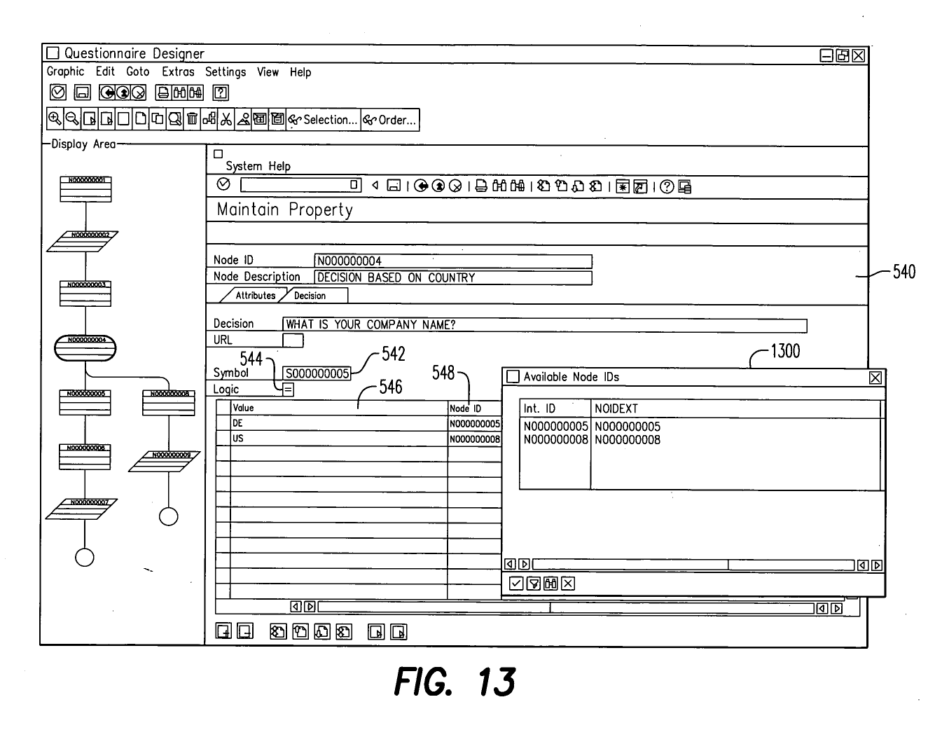

According to some embodiments, window 1200 is presented upon selection of Symbol field 542. Window 1200 displays all answer fields associated with question nodes that precede the selected decision node (i.e., nodes N000000001 and N000000003). FIG. 13 shows area 540 after selection of answer field S000000005 according to some embodiments.

The “equals” operator in Logic field 544 indicates that the questioning sequence will proceed to either node N000000005 or node N000000008 based on a comparison between an answer associated with answer field S000000005 and the values of Value table 546. More particularly, as shown, the questioning sequence will proceed to node N000000005 if the answer associated with answer field S000000005 is “DE” and will proceed to node N000000008 if the answer associated with answer field S000000005 is “US”. A designer may manipulate window 1300 to populate Node ID column 548.

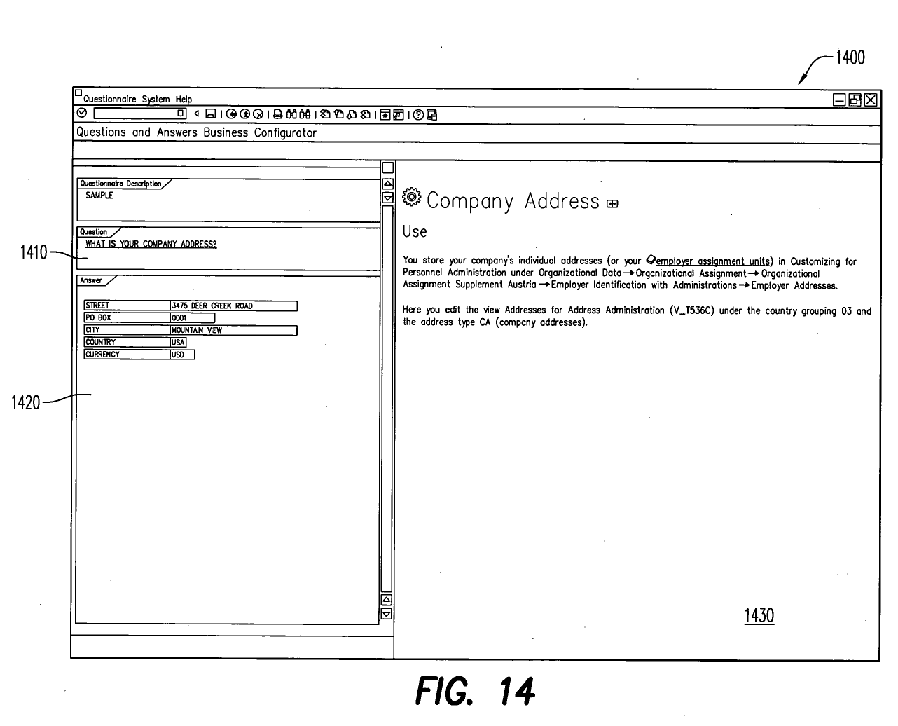

FIG. 14 illustrates window 1400 of user application 420 according to some embodiments. Window 1400 is presented to a user during execution of an executable questionnaire such as executable questionnaire 414. Window 1400 may be presented on a display device different from the device used to present the user interface windows of FIGS. 5 through 13.

Window 1400 presents a question and associated answer fields in accordance with the questionnaire being executed. In the illustrated example, the questionnaire includes a question presented in area 1410 and a plurality of associated answer fields presented in area 1420. The user has input answers associated with each answer field in area 1420. Window 1400 also includes help area 1430 for assisting the user in completing area 1420.

According to some embodiments, user application 420 executes executable questionnaire 414 by proceeding through a desired questioning sequence dictated by the question nodes and the decision nodes of executable questionnaire 414. User application 420 thereby collects answers associated with each answer field of each traversed question node.

Interactive user application 420 may output the collected answers and executable questionnaire 432 to answers administrator 430 of FIG. 4. The answers and questionnaire may be output in any format suitable to answers administrator 430, including but not limited to XML. Answers administrator 430 may comprise an ABAP application executing on an ABAP platform.

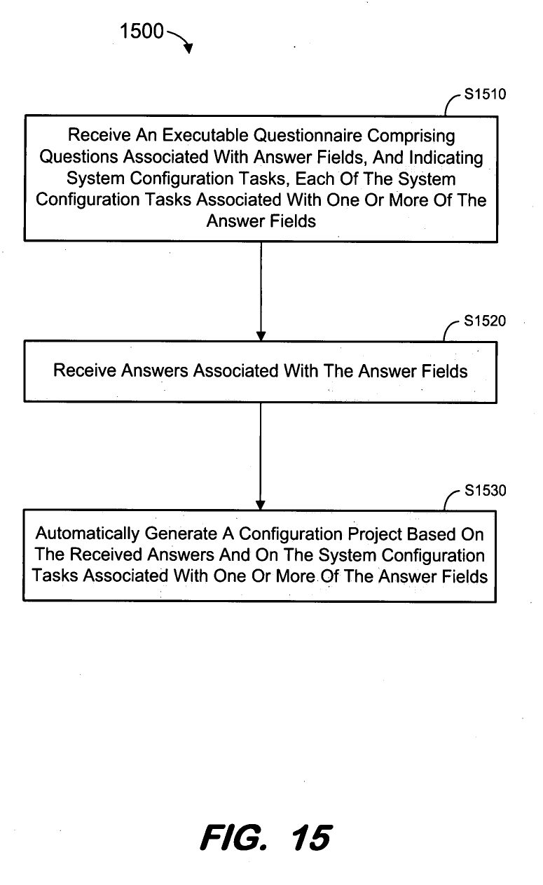

FIG. 15 comprises a flow diagram of process 1500 according to some embodiments. Process 1500 may be embodied in program code of answers administrator 430. Answers administrator 430 may comprise any suitable combination of hardware, program code, and other software.

According to process 1500, an executable questionnaire is received at S1510. The executable questionnaire includes questions associated with answer fields and indicates system configuration tasks. Each of the system configuration tasks is associated with one or more of the answer fields. In some examples of S1510, executable questionnaire 414 is received by answers administrator 430.

Answers associated with the answer fields are then received at S1520. S1510 and S1520 may occur simultaneously in some embodiments. For example, answers administrator 430 may receive a single electronic file including the executable questionnaire and the answers. Such a file may be formatted according to any suitable protocol.

As described above, the received answers correspond to the input fields of one or more system configuration tasks. Accordingly, at S1530, a configuration project is automatically generated based on the received answers and on the system configuration tasks associated with one or more of the answer fields. FIG. 4 shows configuration project 434 that is automatically generated according to some embodiments of S1530.

According to some embodiments, the configuration project is automatically generated by determining a plurality of system configuration tasks of the questionnaire for which all associated answer fields are associated with one of the received answers. The configuration project is then generated to include the determined plurality of system configuration tasks and their associated answers.

FIG. 1600 illustrates window 1600 presented by answers administrator 430 according to some embodiments. Area 1610 of window 1600 presents each of the received answers in conjunction with an associated answer field (e.g., symbol Sxxxxxxxxxx) of the received questionnaire. According to some embodiments, a project generator may review the received answers and edit or otherwise manipulate the answers prior to S1530. Area 1620 represents nodes of the executable questionnaire and may assist the project generator in evaluating the displayed answers.

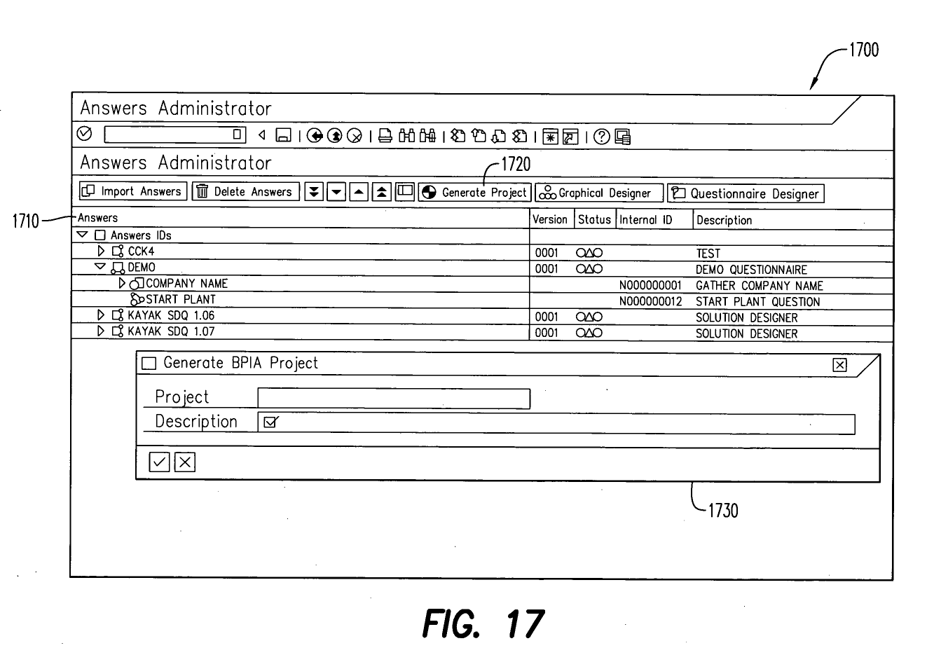

Answers administrator window 1700 of FIG. 17 illustrates automatic generation of a project according to some embodiments. Specifically, a project generator may select Answer ID “Demo” from area 1710 and depress Generate Project button 1720. Window 1730 is displayed in response, allowing the project generator to name the configuration project to be generated and to provide a description thereof.

The generated configuration project (e.g., configuration project 434) may be imported and executed by a suitable runtime environment in order to configure a software system. FIG. 4 shows runtime environment 30 for generating configuration tasks based on configuration project 434. Runtime environment 30 may be compatible with configuration tasks 20 based on which questionnaire 412 was determined. Accordingly, runtime environment 30 may access configuration objects 10 required to perform configuration tasks 20 which may be specified in questionnaire 412.

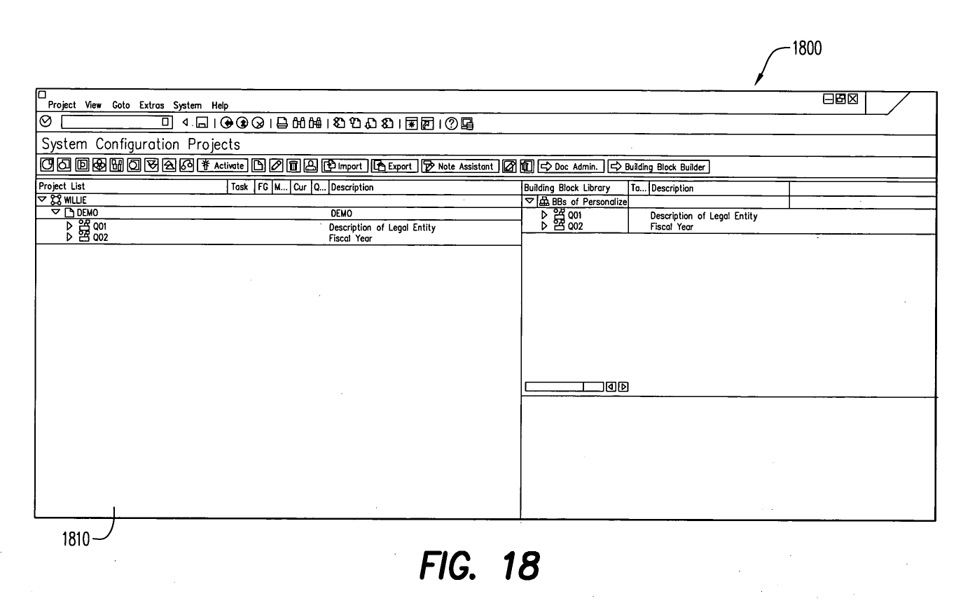

FIG. 18 is a view of window 1800 of a runtime environment which may execute a configuration project according to some embodiments. Window 1800 shows list 1810 of imported configuration projects and tasks associated with each imported project. Configuration objects 10, tasks 20 and runtime environment 30 for execution thereof may comply with any automated configuration system that is or becomes known.

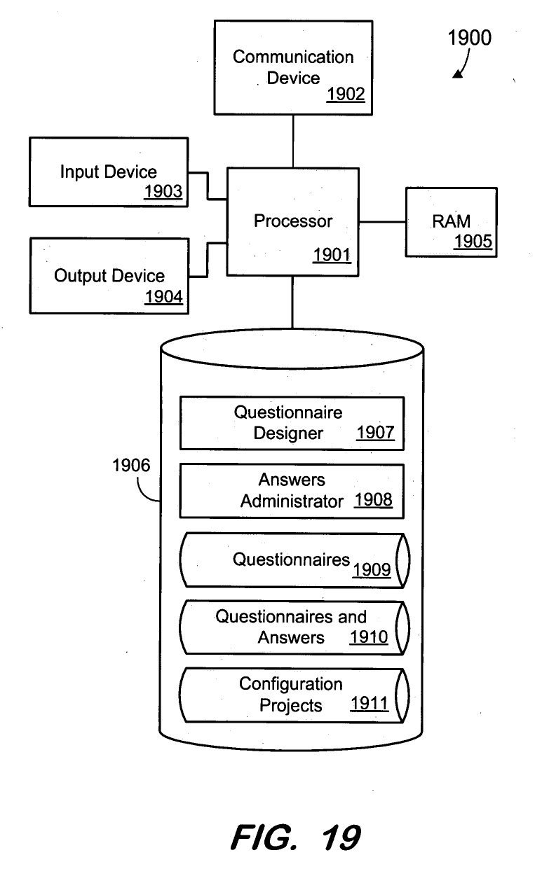

FIG. 19 is a block diagram of an internal architecture of an apparatus according to some embodiments. Apparatus 1900 may embody at least one of questionnaire designer 410 and answers administrator 420 in some embodiments. Apparatus 1900 includes processor 1901 to execute processor-executable program code so as to control the elements of apparatus 1900 to provide functionality such as that described herein.

Communication device 1902 is in communication with processor 1901. Communication device 1902 is used to transmit data to and to receive data from devices external to apparatus 1900 such as a device executing user application 420. Communication device 1902 is therefore preferably configured with hardware suitable to physically interface with desired external devices and/or network connections. For example, communication device 1902 may comprise an Ethernet connection to a local area network through which apparatus 1900 may receive and transmit information over the Web.

Input device 1903 and output device 1904 are also in communication with processor 1901. Any known input device may comprise input device 1903, including a keyboard, mouse, touch pad, voice-recognition system, or any combination of these devices. Of course, information may also be input to apparatus 1900 via communication device 1902. Output device 1903 may be an integral or separate CRT display, flat-panel display or the like used to present user interfaces in response to commands issued by processor 1901.

RAM 1905 provides processor 1901 with fast data storage and retrieval. In this regard, processor-executable program code being executed by processor 1901 is typically stored temporarily in RAM 1905 and executed therefrom by processor 1901.

Data storage device 1906 stores, among other data, processor-executable program code of questionnaire designer 1907 and answers administrator 1908. Apparatus 1900 may execute questionnaire designer 1907 to provide the functions attributed to questionnaire designer 410 herein. Similarly, apparatus 1900 may execute answers administrator 1908 to provide the functions attributed herein to answers administrator 430. Accordingly, apparatus 1900 may execute questionnaire designer 1907 to generate executable questionnaires 1909 and may execute answers administrator 1908 to receive questionnaires and answers 1910 and to generate configuration projects 1911 therefrom.

Data storage device 1906 may also include processor-executable program code of other applications for execution by apparatus 1900. Data storage device 1906 may also store process steps of an operating system (unshown). An operating system provides a platform for executing applications, device drivers and other process steps that interact with elements of apparatus 1900.

Elements described herein as communicating with one another are directly or indirectly capable of communicating over any number of different systems for transferring data, including but not limited to shared memory communication, a local area network, a wide area network, a telephone network, a cellular network, a fiber-optic network, a satellite network, an infrared network, a radio frequency network, and any other type of network that may be used to transmit information between devices. Moreover, communication between systems may proceed over any one or more transmission protocols that are or become known, such as Asynchronous Transfer Mode (ATM), Internet Protocol (IP), Hypertext Transfer Protocol (HTTP) and Wireless Application Protocol (WAP).

The embodiments described herein are solely for the purpose of illustration. Those skilled in the art will recognize other embodiments may be practiced with modifications and alterations limited only by the claims.

What is claimed is:

1. A method comprising:
determining a plurality of questions, each of the plurality of questions associated with one or more answer fields;
associating each of a plurality of system configuration tasks with one or more of the one or more answer fields; and
generating an executable questionnaire including the plurality of questions and indicating the plurality of system configuration tasks and the one or more of the one or more answer fields associated with each of the plurality of system configuration tasks.

2. A method according to claim 1, wherein determining the plurality of questions comprises associating each of the plurality of questions with a respective question node, and
wherein the plurality of question nodes are ordered according to a desired questioning sequence.

3. A method according to claim 2, wherein determining the plurality of questions further comprises determining at least one decision node indicating to which question node the questioning sequence should proceed upon reaching the decision node, and
wherein the indication is based on an answer field associated with a question node ordered prior to the decision node in the questioning sequence.

4. A method according to claim 3, wherein associating each of the plurality of system configuration tasks with one or more of the one or more answer fields comprises determining an action node of the questioning sequence, and
wherein the action node associates one of the system configuration tasks with one or more of the one or more answer fields.

5. A method according to claim 1, wherein the system configuration tasks comprise one or more of ECATTS tasks, BCsets and manual tasks.

6. A method according to claim 1, wherein the executable questionnaire is an extended Markup Language document.

7. A medium storing processor-executable program code, the program code comprising:
code to determine a plurality of questions, each of the plurality of questions associated with one or more answer fields;
code to associate each of a plurality of system configuration tasks with one or more of the one or more answer fields; and
code to generate an executable questionnaire including the plurality of questions and indicating the plurality of system configuration tasks and the one or more of the one or more answer fields associated with each of the plurality of system configuration tasks.

8. A medium according to claim 7, wherein the code to determine the plurality of questions comprises code to associate each of the plurality of questions with a respective question node, and
wherein the plurality of question nodes are ordered according to a desired questioning sequence.

9. A medium according to claim 8, wherein the code to determine the plurality of questions further comprises code to determine at least one decision node indicating to which question node the questioning sequence should proceed upon reaching the decision node, and
wherein the indication is based on an answer field associated with a question node ordered prior to the decision node in the questioning sequence.

10. A medium according to claim 9, wherein the code to associate each of the plurality of system configuration tasks with one or more of the one or more answer fields comprises code to determine an action node of the questioning sequence, and
wherein the action node associates one of the system configuration tasks with one or more of the one or more answer fields.

11. A medium according to claim 7, wherein the system configuration tasks comprise one or more of ECATTS tasks, BCsets and manual tasks.

12. A medium according to claim 7, wherein the executable questionnaire is an eXtended Markup Language document.

13. A method comprising:
receiving an executable questionnaire comprising questions associated with answer fields, and indicating system configuration tasks, each of the system configuration tasks associated with one or more of the answer fields;
receiving answers associated with the answer fields; and
automatically generating a configuration project based on the received answers and on the system configuration tasks associated with one or more of the answer fields.

14. A method according to claim 13, wherein the executable questionnaire and the answers are received within an extended Markup Language document.

15. A method according to claim 13, wherein automatically generating the configuration project comprises:
determining a plurality of system configuration tasks for which all associated answer fields are associated with a received answer; and
automatically generating the configuration project to include the determined plurality of system configuration tasks.

16. A method according to claim 13, wherein the system configuration tasks comprise one or more of ECATTS tasks, BCsets and manual tasks.

17. A method according to claim 13, further comprising:
displaying the received answers prior to automatically generating the configuration project.

18. A method according to claim 13, further comprising:
executing the configuration project to configure an enterprise software system.

19. A medium storing processor-executable program code, the program code comprising:
code to receive an executable questionnaire comprising questions associated with answer fields, and indicating system configuration tasks, each of the system configuration tasks associated with one or more of the answer fields;
code to receive answers associated with the answer fields; and
code to automatically generate a configuration project based on the received answers and on the system configuration tasks associated with one or more of the answer fields.

20. A medium according to claim 19, wherein the executable questionnaire and the answers are received within an extended Markup Language document.

21. A medium according to claim 19, wherein the code to automatically generate the configuration project comprises:
coed to determine a plurality of system configuration tasks for which all associated answer fields are associated with a received answer; and
code to automatically generate the configuration project to include the determined plurality of system configuration tasks.

22. A medium according to claim 19, wherein the system configuration tasks comprise one or more of ECATTS tasks, BCsets and manual tasks.

23. A medium according to claim 19, further comprising:
code to display the received answers prior to automatic generation of the configuration project.

24. A medium according to claim 19, further comprising:
code to execute the configuration project to configure an enterprise software system.

25. A system comprising:
a questionnaire designer to:
determine a plurality of questions, each of the plurality of questions associated with one or more answer fields;
associate each of a plurality of system configuration tasks with one or more of the one or more answer fields; and
generate an executable questionnaire including the plurality of questions and indicating the plurality of system configuration tasks and the one or more of the one or more answer fields associated with each of the plurality of system configuration tasks; and
an answers administrator to:
receive an executable questionnaire comprising questions associated with answer fields, and indicating system configuration tasks, each of the system configuration tasks associated with one or more of the answer fields;
receive answers associated with the answer fields; and
automatically generate a configuration project based on the received answers and on the system configuration tasks associated with one or more of the answer fields.

26. A system according to claim 25,
wherein determination of the plurality of questions comprises association of each of the plurality of questions with a respective question node,
wherein the plurality of question nodes are ordered according to a desired questioning sequence,
wherein determination of the plurality of questions comprises determination of at least one decision node indicating to which question node the questioning sequence should proceed upon reaching the decision node,
wherein the indication is based on an answer field associated with a question node ordered prior to the decision node in the questioning sequence,
wherein association of each of the plurality of system configuration tasks with one or more of the one or more answer fields comprises determination of an action node of the questioning sequence, and
wherein the action node associates one of the system configuration tasks with one or more of the one or more answer fields.

27. A system according to claim 25, wherein automatic generation of the configuration project comprises:
determination of a plurality of system configuration tasks for which all associated answer fields are associated with a received answer; and
automatic generation of the configuration project to include the determined plurality of system configuration tasks.
